(19) United States
(12) Patent Application Publication
(10) Pub. No.: US 2012/0228465 A1
(43) Pub. Date: Sep. 13, 2012

(54) MOUNTING APPARATUS FOR FANS

(75) Inventor: LEI LIU, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 13/078,009

(22) Filed: Apr. 1, 2011

(30) Foreign Application Priority Data
Mar. 7, 2011 (CN) 201110053230.0

(51) Int. Cl. F16M 13/02

(52) U.S. Cl. 248/674

(57) ABSTRACT

A mounting apparatus includes a mounting bracket fixed in a chassis, and a number of base members respectively attached to a number of fans of different sizes. The base members are mounted to the mounting bracket at selected positions of the mounting bracket. Each of the base members defines a number of groups of mounting holes, thereby allowing mounting of different sized fans.

### BACKGROUND

1. Technical Field

The present disclosure relates to fan mounting technologies.

2. Description of Related Art

Electronic devices, such as servers, contain fans to dissipate heat produced by electronic components. The devices generally include a mounting apparatus for mounting the fans. However, the mounting apparatus can only mount fans of a particular size at pre-determined positions. Therefore, replace the fans with fans of a different size, or to relocate the fans, the mounting apparatus must be replaced, which is inconvenient and costly.

### BRIEF DESCRIPTION OF THE DRAWINGS

Many aspects of the present embodiments can be better understood with reference to the following drawing. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a mounting apparatus, a chassis, and a plurality of fans, the mounting apparatus including a mounting fame and a plurality of base members.

FIG. 2 is an enlarged view of circled portion II of FIG. 1.

FIG. 3 is an assembled, isometric view of one of the fans, and one of the base members of FIG. 1.

FIG. 4 is an assembled, isometric view of FIG. 1.

FIG. 5 is an enlarged view of circled portion V of FIG. 4.

FIG. 6 is similar to FIG. 3, but the fan having been replaced with another fan of a different size.

FIG. 7 is similar to FIG. 4, but one of the fans has been replaced with another fan of a different size.

### DETAILED DESCRIPTION

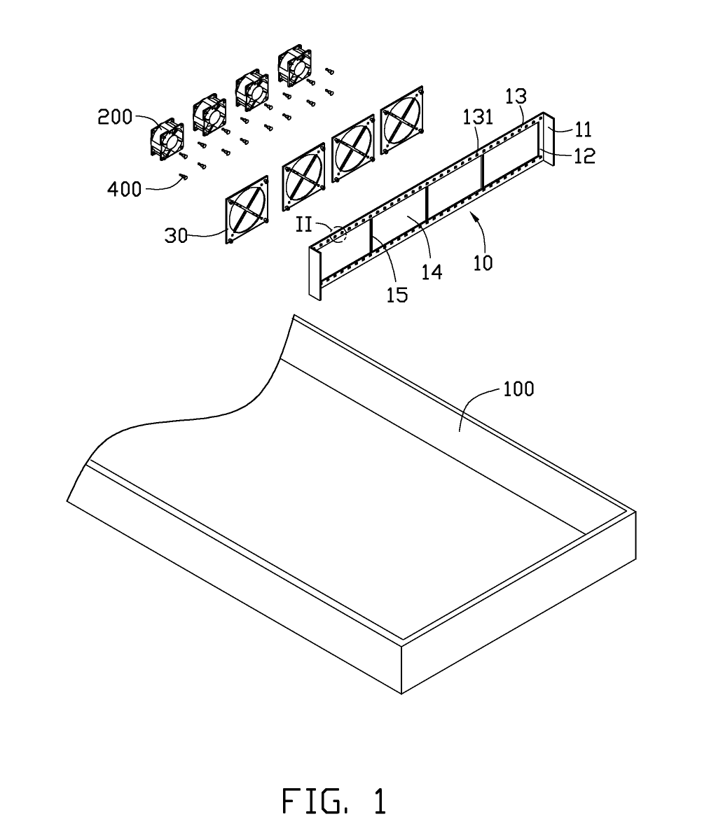

Referring to FIG. 1, an embodiment of a mounting apparatus is provided for mounting a plurality of fans 200 to a chassis 100. Each of the fans 200 includes opposite rectangular end plates (not labeled). Each of the end plates defines four fixing holes (not labeled), respectively arranged at four corners of the end plate. The mounting apparatus includes a mounting frame 10 and a plurality of base members 30.

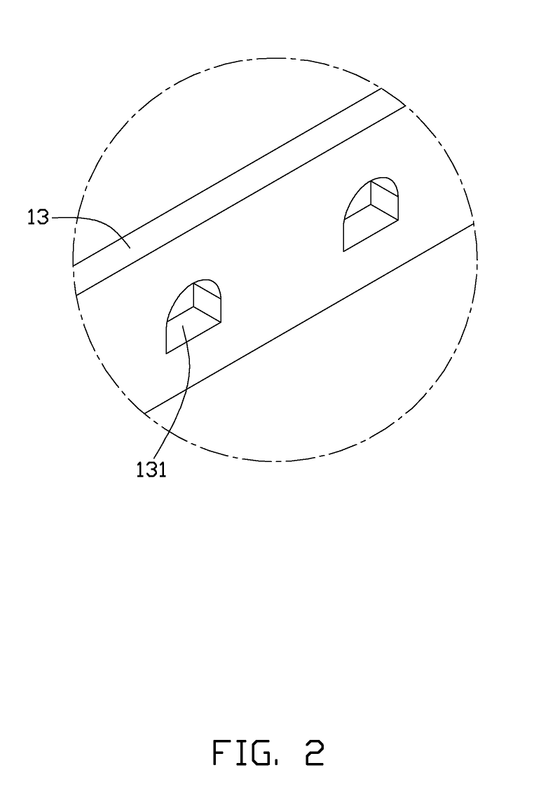

Referring to FIG. 2, the mounting frame 10 includes a board 12 and two sidewalls 11 substantially perpendicularly extending from opposite ends of the board 12. The board 12 lengthwise defines a plurality of openings 14 therein. A reinforcing bar 15 is formed between every two adjacent openings 14. Two opposite attachment bars 13 are formed on the board 12, at top and bottom sides of the openings 14. Each of the attachment bars 13 defines a plurality of substantially semi-circular positioning holes 131, arranged along a longwise direction of the attachment bar 13. An arced top side and a straight bottom side bounds each of the positioning holes 131.

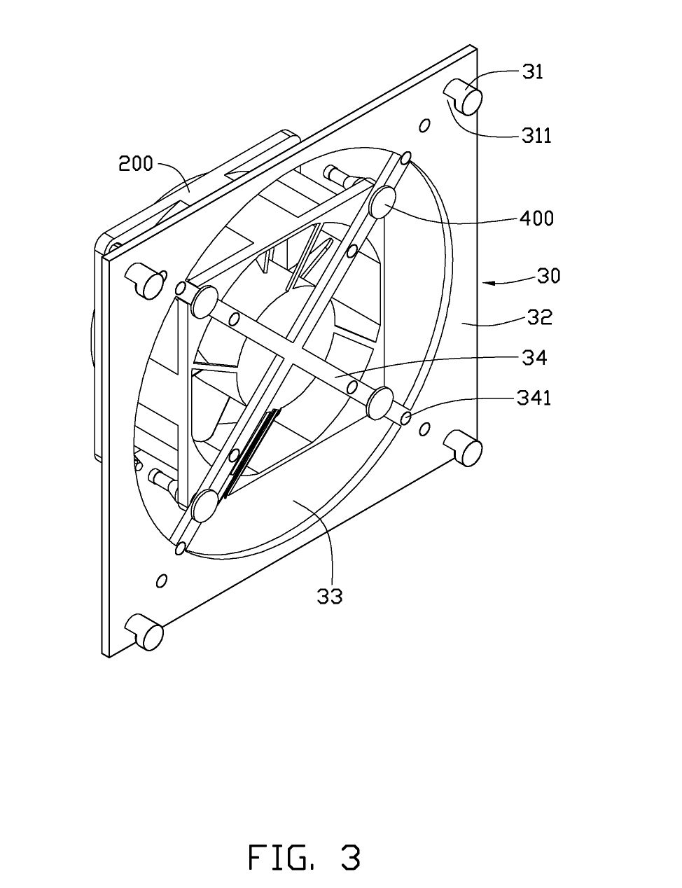

Referring to FIG. 3, each of the base members 30 includes a substantially rectangular base plate 32, and four positioning posts 31 perpendicularly extending from four corners of a side of the base plate 32. The base plate 32 defines a round through hole 33 in a center of the base plate 32, and includes two engaging bars 34, crossed with each other at a crossing point, and located in the through hole 33, and connected to a side bounding the through hole 33. A plurality of groups of mounting holes 341 is defined in the base plate 32, and arranged at four directions along the two engaging bars 34. Each group of mounting holes 341 includes four mounting holes 341, respectively in the two engaging bars 34 in the four directions from the crossing point. Therefore, different groups of mounting holes 341 have difference distances from the center of the through hole 33 and enable the base member 30 to be connected to one of a plurality of fans of different sizes. Each of the positioning posts 31 defines a groove 311 in the bottom of the positioning post 31, adjacent to the base plate 32.

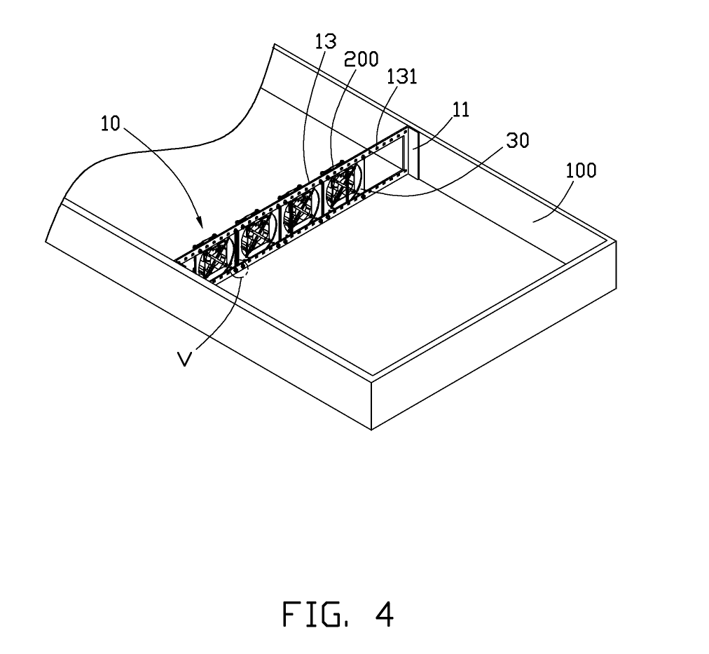

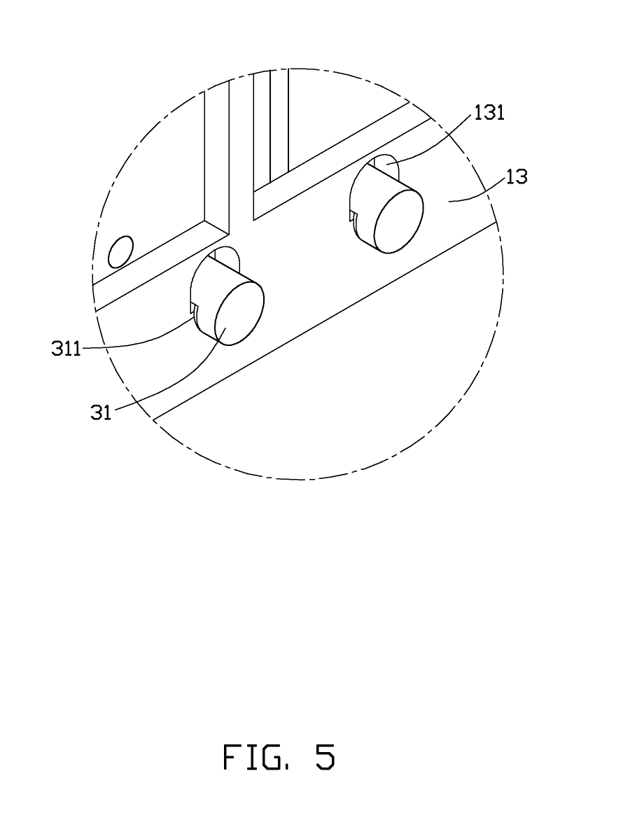

Referring to FIGS. 3 to 5, the mounting frame 10 may be fixed in the chassis 100 by riveting or screwing.

In assembly of one of the fans 200 and one of the base members 30, one of the end plates of the fan 200 abuts against a side of the base plate 32 of the base member 30, opposite to the engaging posts 31 of the base member 30. The fixing holes of the fan 200 are correspondingly aligned with a corresponding group of mounting holes 341 of the base member 30. Four fixing pins 400 extend through the group of mounting holes 341 of the base member 30 and are fixed in the corresponding fixing holes of the fan 200, thereby fixing the base member 30 to the fan 200. To mount the fan 200 to the mounting frame 10, the positioning posts 31 of the base member 30 are extended into a corresponding four of the positioning holes 131. Two of the four positioning holes 131 are located at one of the mounting bars 13, the other two positioning holes 131 are located at the other mounting bar 13. The fan 200 and the base member 30 are slid downwards to allow the bottom sides bounding the positioning holes 131 to engage in the grooves 311 of the corresponding positioning posts 31. Therefore, the base member 30 and the fan 200 are secured to the mounting fame 10, with the fan 200 aligned with a corresponding opening 14 through the through hole 33. To relocate the fan 200, the positioning poles 31 can be engaged in other positioning holes 131. Other fans 200 are mounted to the mounting fame 10 the same way as described above.

To detach one of the fans 200 from the mounting frame 10, the fan 200 is slid upwards to disengage the engaging posts 31 from the bottom sides bounding the corresponding positioning holes 131, then the fan 200 is moved away from the mounting frame 10, with the engaging posts 31 moving out of the corresponding positioning holes 131, thereby disengaging the fan 200 from the mounting frame 10.

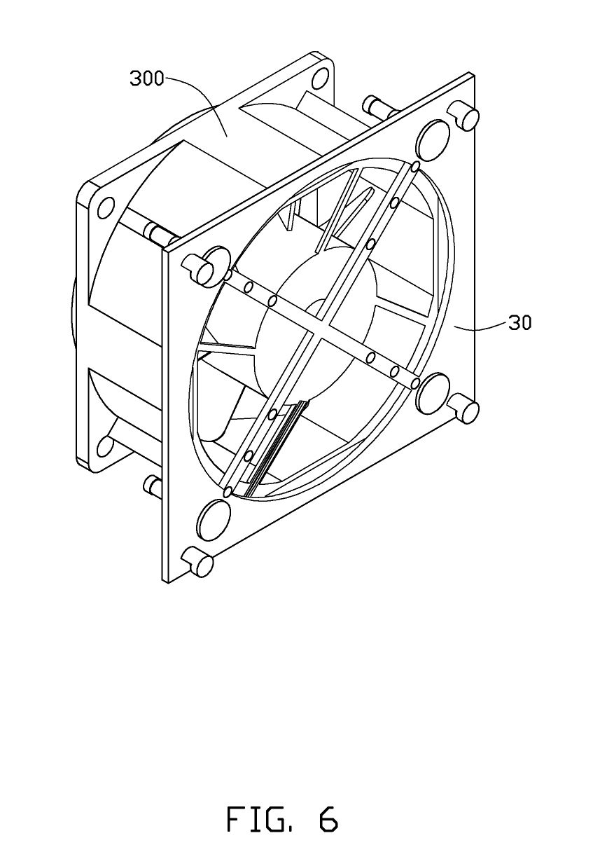

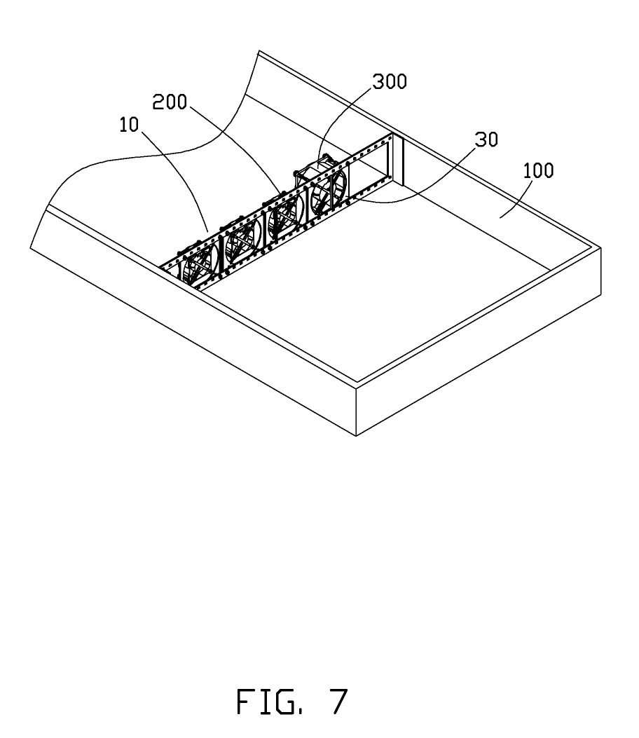

Referring to FIGS. 6 and 7, to replace one of the fans 200 with a fan 300 with a greater size than the fan 200, the fixing pins 400 are removed from the fan 200 and the corresponding base member 30 to detach the fan 200 from the base member 30. The fan 300 is mounted to the base member 20, with the fixing pins 400 engaging in another group of mounting holes 341 corresponding to the size of the fan 300. The fan 300 is then ready to be mounted to the mounting frame 10 by engaging the base member 30 to the mounting frame 10.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus for mounting a fan to a chassis, the mounting apparatus comprising:
a mounting frame to be fixed to the chassis; and
a base member attached to the fan, and mounted to the mounting frame;
wherein the base member is detachably mounted to the mounting frame, the base member defines a plurality of groups of mounting holes, each group of mounting holes is adapted to mount one of a plurality of fans of different sizes.

2. The mounting apparatus of claim 1, wherein the mounting frame is substantially rectangular, and comprises opposite attachment bars, each of the attachment bars defines a plurality of positioning holes, arranged along a longwise direction of the attachment bar, the base member comprises a plurality of positioning posts, each of the positioning posts is selectively engaged in one of the positioning holes of the mounting frame.

3. The mounting apparatus of claim 2, wherein each of the positioning holes of the mounting frame is substantially semi-circular, and bounded with an arced top side and a straight bottom side, each of the engaging posts of the base member defines a groove in a bottom of the engaging post to engage with the bottom side of a corresponding one of the positioning holes of the mounting frame.

4. The mounting apparatus of claim 2, wherein the base member comprises a substantially rectangular base plate, the plurality of positioning posts comprises four positioning posts perpendicularly extending from four corners of a side of the base plate.

5. The mounting apparatus of claim 4, wherein the base plate defines a round through hole, and comprises two engaging bars crossed with each other at a crossing point and located in the through hole, the mounting holes are arranged at four directions along the two engaging bars, each group of mounting holes comprises four of the mounting holes respectively in the two engaging bars in the four directions from the crossing point, spaced from the center of the through hole the same distance.

6. An assembly comprising:
a chassis;
a mounting frame fixed to the chassis;
a plurality of base members connected to the mounting frame at selected positions of the mounting frame; and
a plurality of fans correspondingly mounted to the base members;
wherein each of the base members defines a plurality of groups of mouthing holes, one of the groups of mounting holes is employed for mounting the corresponding fan in response to a particular size of the corresponding fan.
